(19) United States
(12) Patent Application Publication
(10) Pub. No.: US 2002/0199053 A1
(43) Pub. Date: Dec. 26, 2002

(54) USB interface device of peripheral device

(76) Inventor: Kunihiro Kondoh, Kanagawa (JP)

Correspondence Address: STEVEN I WEISBUED ESQ, DICKSTEIN SHAPIRO MORN & OSHINSKY LLP, 1177 AVENUE OF THE AMERICAS, 41TH FLOOR, NEW YORK, NY, 10036-2714, US

(21) Appl. No.: 10/114,062

(22) Filed: Apr. 3, 2002

(30) Foreign Application Priority Data
Apr. 10, 2001 (JP) 111504/2001

(51) Int. Cl. G06F 13/36

(52) U.S. Cl. 710/310

(57) ABSTRACT

A memory controller in a USB interface device periodically receives schedule information from a USB host controller in a computer by the interrupt transfer as periodic transfer with the highest priority in the USB transfer systems, stores the received schedule information in a schedule register in a transaction control unit, and controls the buffering in accordance with the stored schedule information.

### BACKGROUND OF THE INVENTION

1. Field of the Invention

The present invention relates to a USB (Universal Serial Bus) interface device of a peripheral device, and more particularly, to a USB interface device of a peripheral device, for receiving and transmitting data via an interface in conformity with a USB standard via which a computer is connected to the peripheral device by solving a problem to increase the memory capacity and the circuit scale in accordance with the number of end points of the peripheral device.

2. Description of the Related Art

It is well known that in recent years, LSIs consisting of a semiconductor device increase in scale and speed in accordance with the sophisticated technologies for allowing semiconductor devices to have fine structure of semiconductor elements. In particular, microprocessors as CPUs increase in speed, and storage devices corresponding thereto extremely increase in scale. For example, in semiconductor storage devices used for external storage devices, a DRAM (Dynamic Random Access Memory) having 256 MB formed in one chip is put into practical use. These technologies for fine semiconductor devices are applied to microcomputers and internal memory devices provided therein, contributing to the increase in memory capacity of the internal memory device.

Meanwhile, the USB is well known as an interface standard between a host computer and a peripheral device thereof in the microprocessors and an application system having the above microprocessor. Mainly, interfaces in computer systems such as a personal computer use the technology for data transfer using the interface in conformity with the USB standard. In the data transfer, data is transferred between a host computer and the USB interface via a serial bus and a plurality of peripheral devices are simultaneously accessed at end points thereof if necessary.

The end point corresponds to receiving and transmitting means from/to which a USB host controller included in the computer receives and transmits data on FIFO minimum unit basis to the peripheral devices. A plurality of end points exist and the USB host controller transmits and receives the data based on device addresses assigned to the end points.

As mentioned above, in general, the USB interface device in the peripheral device supports the plurality of end points. However, conventional USB interface device generally has a memory area for assuring the throughput of data transfer at each supported end point.

Therefore, in accordance with the number of end points, the increase in memory capacity and in circuit scale becomes a problem. However, many USB interface devices have several end points, the ratio of the memory area for the USB interface device to the overall system memory is small, and the problem of the increase in circuit scale therefore does not become serious.

However, the USB standard is changed from Rev. 1.1 to Rev. 2.0 and then the maximum packet size for transferring data once is extended. More specifically, the bulk transfer for transferring data having periodically relatively-large size is extended from 64 bytes to 512 bytes as eight multiples thereof, and the interrupt transfer for periodic data-transfer is extended from 64 bytes to 1,024 bytes as sixteen multiples thereof.

Accordingly, the circuit scale is extremely increased due to the extension of the memory size. Although the above-mentioned advancement of the technology for fine semiconductor device contributes to the increase in memory capacity of the internal memory device, the problem becomes serious.

As disclosed in Japanese Unexamined Patent Application Publication No. 11-328069 (referred to as a first cited reference), a first conventional data transfer device to solve the above problem to the extreme increase in circuit scale is proposed.

FIG. 2 is a block diagram showing the first conventional data transfer device disclosed in the first cited reference. Referring to FIG. 2, the first conventional data transfer device comprises a host computer 21, a peripheral device 22 connected to the host computer 21 via a USB cable, a USB interface device 23 incorporated in the peripheral device 22, and a microcomputer 24.

The USB interface device 23 comprises a memory controller 26, a serial interface engine 25, a CPU bus interface 27, a transmission-address control unit 28, a reception-address control unit 33, a transmitting memory 35, and a receiving memory 36. The memory controller 26 comprises a plurality of EP control units 30.

The memory controller 26 controls the reception and transmission of data transferred between the host computer 21 and the peripheral computer 22. The serial interface engine 25 controls the USB interface operation for converting reception data in parallel and serially converting transmission data.

The CPU bus interface 27 functions as an interface for receiving and transmitting a control signal and data from/to the memory controller 26 and the microcomputer 24 incorporated in the peripheral device 22.

The transmission-address control unit 33 controls the setting of the transmission address for each end point. The reception-address control unit 34 controls the setting of the reception address for each end point.

The transmitting memory 35 controls the operation for storing the transmission data to the computer 21 from the peripheral device 22. The receiving memory 36 controls the operation for storing the transmission data to the peripheral device 22 from the computer 21.

Differently from the general USB interface devices, the above first conventional data transfer device includes the single transmitting memory 35 as a data holding area at all end points for transmission. Similarly to the end point for transmission, a data holding area at all end points for reception consists of the single receiving memory 36. In other words, the two memories of the transmitting memory 35 and the receiving memory 36 may be provided for a plurality of end points.

Namely, a memory for transmission data and a memory for reception data is shared at a plurality of end points and, thereby, the number of memories may be two without requiring the memory for each end point.

It is not so difficult to simply share the receiving and transmitting buffer (memory) at a plurality of end points in the peripheral device. Under the condition of the USB interface in that the host controller manages the data transfer and the timing to send the request of the data transfer to the peripheral device is arbitrary, if the receiving and transmitting memory is shared, the buffering control is performed after the data transfer is received from the host controller by the peripheral device.

If the data transmission is requested in the case of a free memory, the data is written to the memory after the transmission request is received. As a consequence, the actual data-transmission is delayed by a time to write the transmission data to the memory and it is extremely delayed from the transmission request timing.

On the contrary, since the transmission data is stored in the memory and when the reception is requested, the data in the memory must temporarily deleted, the transmission is difficult.

Since the sharing of the receiving and transmitting memories causes the above problem if the memory becomes free or the data is written to the memory in advance, the general USB interface devices assure the memory for each of the reception and transmission.

The transmission data is stored in the transmitting memory and the receiving memory is free and, thus, the data can promptly be transferred in response to the transmission request and the receiving request.

As mentioned above, in the conventional data transfer device, instead of using a plurality of memories, the single memory for each of the transmission and the reception can reduce the circuit scale shared by the memory.

However, a memory area must be assigned to each end point and the total of the memory capacity cannot be reduced. Therefore, the effect for substantially reducing the circuit scale is exceedingly low.

As disclosed in Japanese Unexamined Patent Application Publication No. 2000-183939 (referred to as a second cited reference), a second conventional data transfer device controls the operation for directly transmitting data received from one peripheral device to another peripheral device. That is, a hub device performs the control operation which is normally executed by a host controller.

### SUMMARY OF THE INVENTION

Accordingly, the present invention is devised in consideration of the above conventional problems, and it is one object of the present invention to provide a USB interface device of a peripheral device, for highly reducing the circuit scale by sharing a single memory for an FIFO memory at each end point or for FIFO memories at end points for transmission and reception and by providing a memory capacity corresponding to an end point having a maximum packet size.

It is another object of the present invention to provide a USB interface device of a peripheral device, for buffering control in accordance with a data transfer schedule in a transaction list (schedule information) obtained from a host computer, not for directly transmitting data to another peripheral device.

According to a first aspect of the present invention, there is provided a USB interface device of a peripheral device, for periodically receiving and transmitting from a computer a transaction list including a data size, an end-point number, and a device address as schedule information stored in the computer for data transfer via a USB interface, comprising:

memory means at least one of memory means for writing reception and transmission data and memory means for reading the written reception and transmission data to/from the computer via the USB interface; and

memory control-means at least one of memory control means for controlling the buffering of writing the reception and transmission data to said memory means and memory control means for controlling the buffering of reading the written reception and transmission data, based on said transaction list.

According to a second aspect of the present invention, there is provided a USB interface device of a peripheral device, for periodically receiving and transmitting from a computer a transaction list including a data size, an end-point number, and a device address as schedule information stored in the computer for data transfer via a USB interface, comprising:

memory means at least one of memory means for writing reception and transmission data and memory means for reading the written reception and transmission data to/from said computer via the USB interface; and

memory control means at least one of memory control means for controlling the buffering of writing the reception and transmission data to said memory means and memory control means for controlling the buffering of reading the written reception and transmission data, based on the transaction list,

wherein the memory means shares single memory means for receiving and transmitting data to/from the computer.

According to a third aspect of the present invention, there is provided a USB interface device of a peripheral device, for periodically receiving and transmitting from a computer a transaction list including a data size, an end-point number, and a device address as schedule information stored in the computer for data transfer via a USB interface, comprising:

memory means at least one of memory means for writing reception and transmission data and memory means for reading the written reception and transmission data to/from said computer via the USB interface; and

memory control means at least one of memory control means for controlling the buffering of writing the reception and transmission data to said memory means and memory control means for controlling the buffering of reading the written reception and transmission data,based on the transaction list,

wherein the memory means shares single memory means for receiving and transmitting data to/from the computer, and all end points as minimum units of the data transfer via the USB interface in the peripheral device share single memory means single memory means at least one of single memory means for writing and single memory means for reading the reception and transmission data in response to the control operation which is performed by combining a data-transfer requesting function for transmitting the schedule information from the computer and a buffering-control function of the reception and transmission data in accordance with the schedule information transferred by the data-transfer requesting function.

Further, in the present invention, the USB interface device of the peripheral device has the following preferable applications.

That is, in the present invention, the memory means sets in advance a memory capacity of the memory means to be a capacity value-corresponding to a capacity at the end point having a maximum packet size among from the end points.

According to a fourth aspect of the present invention, there is provided a USB interface device of a peripheral device, for periodically receiving and transmitting from a computer a transaction list including a data size, an end-point number, and a device address as schedule information stored in the computer for data transfer via a USB interface, comprising:

a serial interface engine for converting reception and transmission data in parallel or serially;

memory means for storing the reception and transmission data;

a CPU bus interface as an interface between the peripheral device and a microcomputer incorporated therein, at least one of for writing the reception and transmission data transferred to the microcomputer and for reading the reception and transmission data from the memory means;

a transaction control unit for activating an end point based on schedule information transferred from the computer for the data transfer via a USB interface; and

a memory controller for controlling the buffering to the memory means in accordance with the reception and transmission of the schedule information transferred from the computer.

Further, in the present invention, the USB interface device of the peripheral device has the following preferable applications.

That is, in the present invention, the memory controller has a function for the data transfer to the end point as the minimum unit in the data transfer via the USB interface and for the hand shake and a function for storing reception data to a schedule register in the transaction control unit, and

the memory controller comprises:

an end-point control unit corresponding to the number of end points; and

an address control unit for selecting a control signal from the end-point control unit based on an activated valid end-point signal and for generating an address in accordance with the input and output of data to the memory means.

Furthermore, in the present invention, the transaction control unit comprises:

a schedule data register for inputting and storing the schedule information from the memory controller; and

a schedule data decoder for inputting next transfer information from the schedule data register, decoding the inputted schedule information, and setting only the end point as a transfer target to be valid.

In addition, in the present invention, the USB interface device further comprises external memory means which is provided outside the USB interface means, in place of the memory means.

According to a fifth aspect of the present invention, there is provided a USB interface device of a peripheral device comprising a microcomputer for periodically receiving and transmitting from a computer a transaction list including a data size, an end-point number, and a device address as schedule information stored in the computer for data transfer via USB interface means, identifying the end-point number as a next-transfer target based on the schedule information, and transferring the identified end-point number to the USB interface means, comprising:

a serial interface engine for converting reception and transmission data to data at least one of parallel data and serial data;

memory means for storing the reception and transmission data;

a transaction control unit for temporarily storing the schedule information from the computer and activating an end point based on the end-point number designated by the microcomputer;

a CPU bus interface as an interface to the microcomputer, at least one of for writing the receiving and transmitting data transferred to said microcomputer to said memory means and for reading the reception and transmission data from the memory means, transferring the schedule information read from the transaction control unit to the microcomputer, and writing the end-point number to be transferred from the microcomputer to the transaction control unit; and

a memory controller for controlling the buffering to the memory means in accordance with the reception and transmission of the schedule information transferred by the computer.

Further, in the present invention, the USB interface device of the peripheral device has the following preferable applications.

That is, in the present invention, the transaction control unit comprises:

a schedule data register for inputting and storing the schedule information from the memory controller; and

an end-point-number register for setting the end point to be valid based on the data written from the CPU bus interface.

### BRIEF DESCRIPTION OF THE DRAWINGS

FIG. 1 is a block diagram showing the structure of a conventional USB interface device of a terminal adaptor in comparison with that of the present invention;

FIG. 2 is a block diagram of a conventional data transfer device in comparison with that of the present invention;

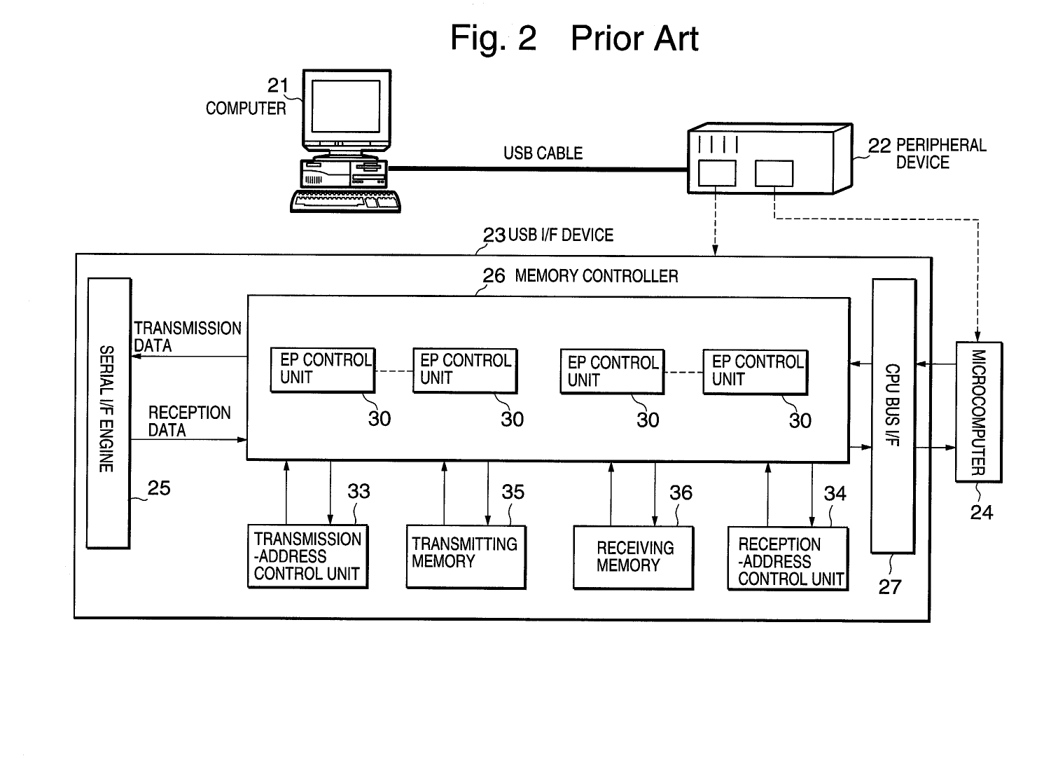

FIG. 3 is a block diagram showing the structure of a USB driver in a host computer according to a first embodiment of the present invention;

FIG. 4 is a block diagram showing the structure of a USB interface device of a peripheral device in the present invention;

FIG. 5 is a block diagram showing the structure of a transaction control unit 28a;

FIG. 6 is a flowchart for explaining a control method of the USB interface device according to the first embodiment of the present invention;

FIG. 7 is a diagram showing the structure of a USB interface device of a host computer according to a modification of the first embodiment;

FIG. 8 is a block diagram showing the structure of a USB interface device of a peripheral device according to a second embodiment of the present invention;

FIG. 9 is a flowchart for explaining a control method of the USB interface device according to the second embodiment;

FIG. 10 is a block diagram showing the structure of a USB interface device of a peripheral device according to a third embodiment of the present invention;

FIG. 11 is a diagram showing the structure of a transaction control unit 28b according to the second embodiment; and

FIG. 12 is a flowchart for explaining a control method of the USB interface device according to the third embodiment of the present invention.

### DESCRIPTION OF THE PREFERRED EMBODIMENTS

Hereinbelow, a description is given of control methods of USB interface devices according to embodiments of the present invention with reference to the drawings.

According to the embodiments of the present invention, summarily, the control methods of the USB interface devices use the interrupt transfer as periodic data-transfer with the highest priority in the USB transfer systems. The USB interface device periodically receives schedule information in a USB host controller, and controls the buffering operation in accordance with the received information, that is, performs the control operation for temporarily reading and writing data to a memory. That is, in the present invention, the control operation is executed by a memory controller.

The contents of schedule information consist of information necessary for the data transfer, such as a device address assigned to the peripheral device, an end-point number as an FIFO minimum unit of the data transfer in the peripheral device, and data transfer size.

A list formed by arranging the schedule information in order of the data transfer is referred to as a transaction list and is represented as schedule information in the present invention.

When the peripheral device is connected to the host controller, first, device information is transmitted to the host controller via a USB cable. The device information consists of the number of used end-points, a transfer method, a transfer direction, and a maximum packet size, etc. at each end-point.

The host controller forms the schedule for data transfer based on the received device information while assuring the necessary data band, and stores the formed schedule in the transaction list. The host controller sends a request of the data transfer to each peripheral device in accordance with the transaction list and thus assures the data bands for all the peripheral devices.

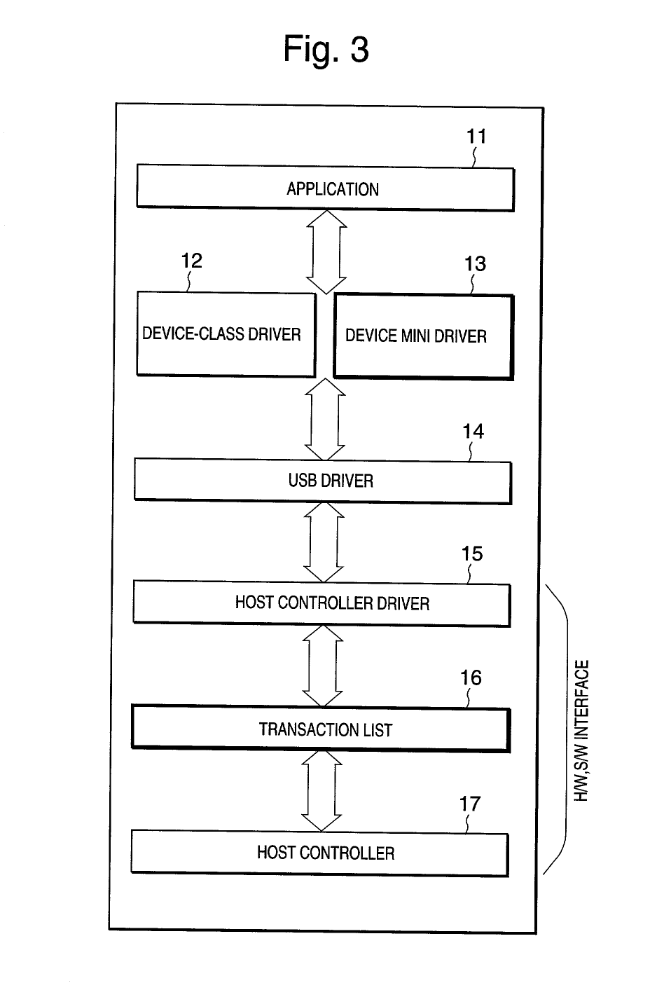

FIG. 3 is a block diagram showing the structure of a USB driver of the host computer in a computer system according to a first embodiment of the present invention, which will be described later. Referring to FIG. 3, the USB driver is incorporated in a host computer 21, and a device mini driver 13 for controlling a peripheral device corresponding to the USB interface (hereinafter, referred to as a USB peripheral device) comprises therein means for obtaining a transaction list 16 for storing the schedule information of the data transfer via the USB interface.

The device mini driver 13 extracts from the obtained transaction list 16 only information on the USB peripheral device to which the data is to be transferred, and request that the host controller 17 transmits the schedule information to the USB peripheral device to which the data is to be transferred from the host controller 17.

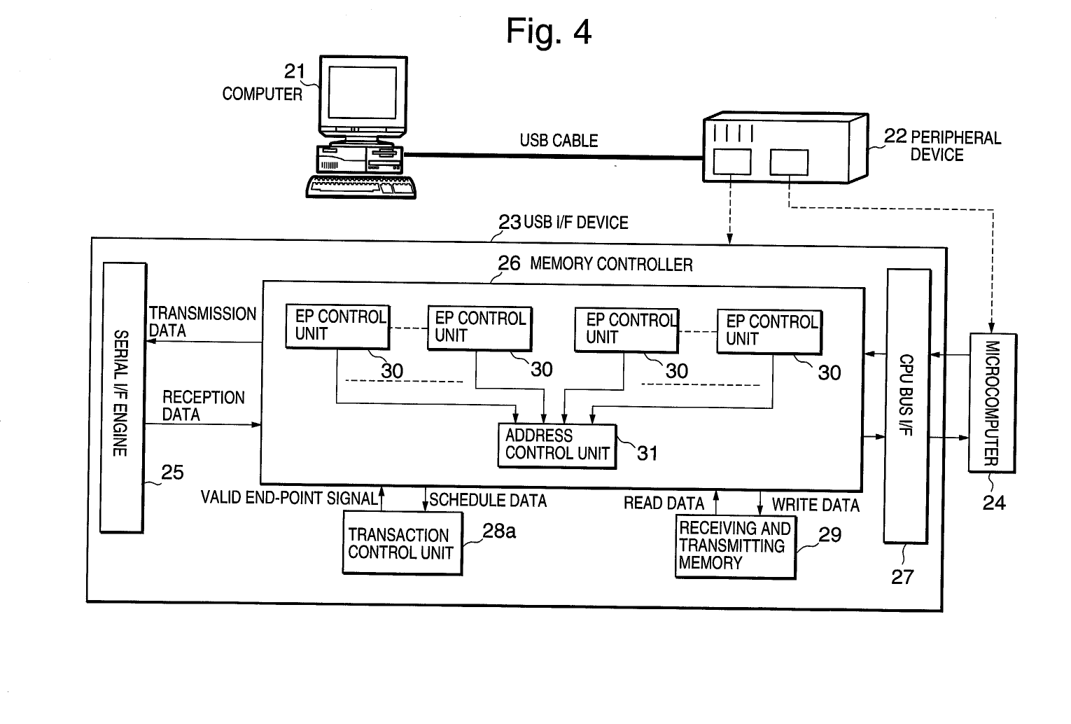

FIG. 4 is a block diagram showing the structure of a USB interface device of the USB peripheral device in the present invention, which will be described later. Referring to FIG. 4, a USB interface device 22 performs the buffering control of the reception and transmission data in accordance with the schedule information obtained from the computer 21.

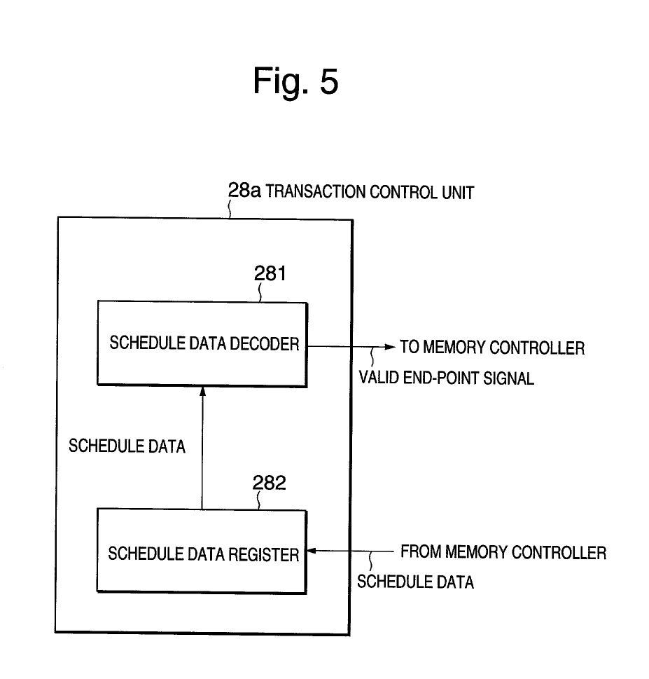

In the buffering control, the writing of the transmission data or the reading of the reception data may be controlled based on the schedule information obtained from the computer 21. FIG. 5 is a block diagram showing the structure of a transaction control unit 28a, which will be described later. The buffering control can be executed by a simple circuit as shown in FIG. 5.

By combining the above-mentioned two techniques, the buffering can appropriately be controlled corresponding to the USB interface. Thus, although data storing means such as the FIFO memory is conventionally provided for each end point or the end point for each of transmission and reception, it can consist of a single memory in the present invention.

The memory capacity may be assured corresponding to the number of end points having the maximum packet size. Therefore, the circuit scale can extremely be reduced.

Next, embodiments of the present invention will be described with reference to FIGS. 3 to 5. Among the components in the diagrams, the same reference numerals designate the common components.

Referring to FIG. 3, the host controller 17 is hardware for controlling the data transfer of the USB peripheral device connected to the USB cable. In the USB interface device, the host controller is located at the top in the hierarchy and the USB peripheral devices are connected to constitute an associated connection shaped like a tree. The host controller must guarantee the data transfer of all the USB peripheral devices connected thereto, and mediates buses. Specifically, the host controller sends a request of the data transfer to the USB peripheral devices at predetermined time interval.

The host controller 17 manages the schedule of the time intervals based on information which is transmitted to the host controller 17 when the USB peripheral device is connected, specific to the peripheral device. The most important function of the host controller 17 is the schedule management.

The host control driver 15 is software for controlling the host controller 17.

The transaction list 16 is schedule information on the data transfer, which can be accessed from the host controller 17 or the host controller driver 15.

A USB driver 14 is software for accessing basic software (OS) for controlling the computer 21 to the host controller 17.

A device-class driver 12 and the device mini driver 13 is software of the USB peripheral devices for sending the request of the data transfer to the host controller 17.

That is, the USB has a plurality of device class specifications in addition to the basic specification and further has a preferable (specified) specification for each peripheral device.

In general, the USB peripheral device is formed in accordance with any of the device classes, and is operated. A simple connection image is shown as follows.

Basic OS (Windows)------------------------------------
↓
Device-class driver

| | |
|---|---|
| ↓ | [symbol] |
| USB driver | Personal computer |
| ↓ | |
| USB host driver | |
| ↓ | [symbol] |

```
Host controller---------------------------------------
    ↓
USB cable
    ↓
Peripheral device
```

As mentioned above, the USB peripheral devices are connected via some drivers.

The device-class driver 12 is software which is operated in accordance with the USB specification (device class specification) but does not include a function for extracting the schedule information of the present invention.

As described above, the device mini driver 13 may originally be formed, includes the function of the present invention, and is used in place of the device-class driver 12.

The device mini driver 13 obtains the transaction list 16 via the USB driver 14 and the host controller driver 15, and extracts only the information on the USB peripheral device to which the data is to be transferred.

The device mini driver 13 requests the host controller 17 to transmit by the interrupt transfer, the extracted schedule information to the USB peripheral device to which the data is to be transferred.

The device-class driver 12 is a driver which is included in the basic OS of the computer in advance.

In addition, the host computer 21 has an application 11 in the computer corresponding to the USB peripheral device.

Referring to FIG. 4, in the present invention, the interface system comprises the host computer 21, the peripheral device 22 connected to the host computer 21 via the USB cable, the USB interface device 23 incorporated in the peripheral device 22, and the microcomputer 24.

The USB interface device 23 comprises a serial interface engine 25, a memory controller 26, a CPU bus interface 27, a transaction control unit 28, and a receiving and transmitting memory 29. The memory controller 26 has a plurality of EP control units 30.

Referring to FIG. 5, the transaction control unit 28 comprises a schedule data register 282 and a schedule data decoder 281.

Referring to FIGS. 4 and 5, the serial interface engine 25 converts the reception data transferred via the USB cable as serial data into parallel data. Further, the serial interface engine 25 converts into the serial data, the transmission data as the parallel data transmitted to the computer 21 from the USB peripheral device to which the data is to be transferred.

The EP control unit 30 (although a plurality of EP control units exist, herein, referred to as one) controls the transfer of data at the end point as a minimum unit of the data transfer via the USB interface and also controls the hand shake.

The EP control unit 30 for handling the schedule information at the end point stores the reception data in the schedule data register 282 in the transaction control unit 28a.

The schedule data register 282 outputs the next transfer information and transmits the output to the schedule data register 282.

The schedule data decoder 281 decodes the schedule information which is inputted from the schedule data register 282, and sets only a valid end-point signal to be high level as the logic level (hereinafter, referred to as an H-level) at the end point to which the data is to be transferred.

The address control unit 31 controls the writing and the reading of data to/from the receiving and transmitting memory 29. Further, the address control unit 31 selects a control signal from the EP control unit 30 based on the valid end-point signal serving as the H-level, and generates an address of the memory which is used for the control of input and output of the data to/from the receiving and transmitting memory 29.

The CPU bus interface 27 writes the data to the receiving and transmitting memory 29 or reads the data from the receiving and transmitting memory 29 in response to the request from the EP control unit 30 to which the data is to be transferred.

As described above, obviously, by performing the buffering control based on the schedule information, the memory at each end point shares the receiving and transmitting memory 29.

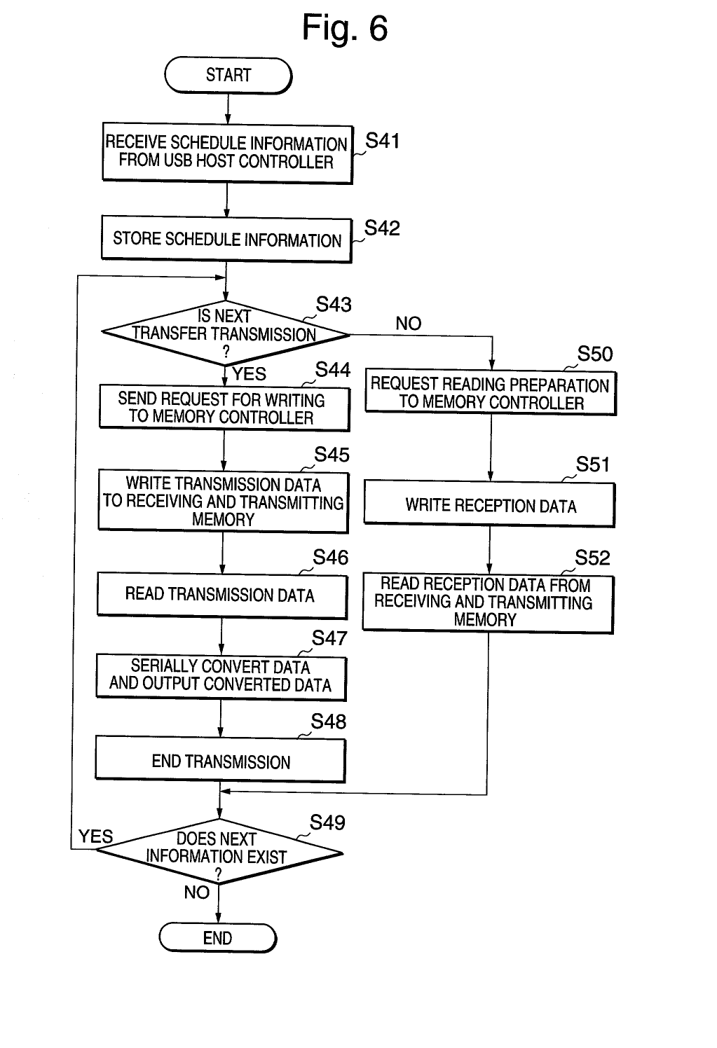

FIG. 6 is a flowchart for explaining a control method of the USB interface device according to the first embodiment of the present invention. Referring to FIG. 6 with FIGS. 3 to 5, first, the host controller 17 transmits by the interrupt-out transfer, the schedule information to the USB peripheral device to which the data is to be transferred in response to the request from the device mini driver 13 (processing step S41).

The USB peripheral device to which the data is to be transferred receives the transmitted data. The serial interface engine 25 in the USB interface device converts the reception data into parallel data and transmits the converted data to the memory controller 26.

In the memory controller 26, the EP control unit 30 to which the data is to be received from among a plurality of EP control units 30, stores the parallel data in the schedule data register 282 in the transaction control unit 28a (processing step S42).

The schedule data register 282 transmits the stored reception data to the schedule data decoder 281. The schedule data decoder 281 decodes first transfer-information which has been transmitted to the schedule data register 282, and sets to the H-level, the valid end-point signal at the end point to which the data is to be next transferred (processing step S43).

The EP control unit 30 to which the data is to be transferred receives the end-point valid signal at the H-level. Then, the EP control unit 30 determines whether the valid end-point shown in processing step S43 is used for reception or transmission. If the EP control unit 30 determines that the valid end point is used for transmission, it requests the microcomputer 24 in the USB peripheral device 22 via the CPU bus interface 27 that the transmission data is written to the corresponding EP control unit 30 in the memory controller 26 (processing step S44).

Next, the memory controller 26 writes the data to be transmitted which is inputted from the microcomputer 24 via the CPU bus interface 27 to the receiving and transmitting memory 29 (processing step S45).

Subsequently, the serial interface engine 25 reads the data to be transmitted which is stored in the receiving and transmitting memory 29 via the memory controller 26 (processing step S46).

The serial interface engine 25 serially converts the data to be transmitted, which is read from the receiving and transmitting memory 29, and sequentially sends the converted data to the computer 21 via the USB cable (processing step S47).

The serial interface engine 25 ends the transfer operation when all data is transmitted (processing step S48).

On the other hand, if it is determined that the valid end-point shown in processing step S43 is used for reception, the EP control unit 30 to which the data is to be received in the memory controller 26 is in the standby mode until the reception data is stored (processing step S50)

When the reception data is received from the computer 21, the serial interface engine 25 converts the reception data into parallel data, and temporarily stores the converted data in the receiving and transmitting memory 29 via the memory controller 26 (processing step S51).

After all the reception data is stored, the memory controller 26 reads all the reception data from the receiving and transmitting memory 29, and transmits the read data to the CPU bus interface 27 (processing step S52).

After completing the transmission/reception processing of one packet, if next transfer information exists, the transaction control unit 28a transmits the next transfer information to the schedule data decoder 281 from the schedule data register 282, and then the sequence from processing step S43 is repeated.

If the next transfer information does not exist, the buffering control ends (processing step S49).

As described above, the memory controller 26 performs the buffering control in accordance with the schedule information of the host controller 17 in the computer 21. Thus, the memory (FIFO) can effectively be used and the receiving and transmitting memory 29 can be shared by the memories at all the end points.

According to the first embodiment, since it is unobvious to which end point the request to transfer the data from the host controller is transmitted, conventionally, the transmission data is written to the transmitting memory in advance. Further, the receiving memory must have a free area to enable the reception of data at any time and must assure the memory area at each end point.

However, in the present invention, by performing the buffering control in accordance with the schedule information of the host controller, the single memory area can be shared at all the end points. Consequently, the circuit scale of the USB interface device can remarkably be reduced without reducing an effective speed of the data transfer.

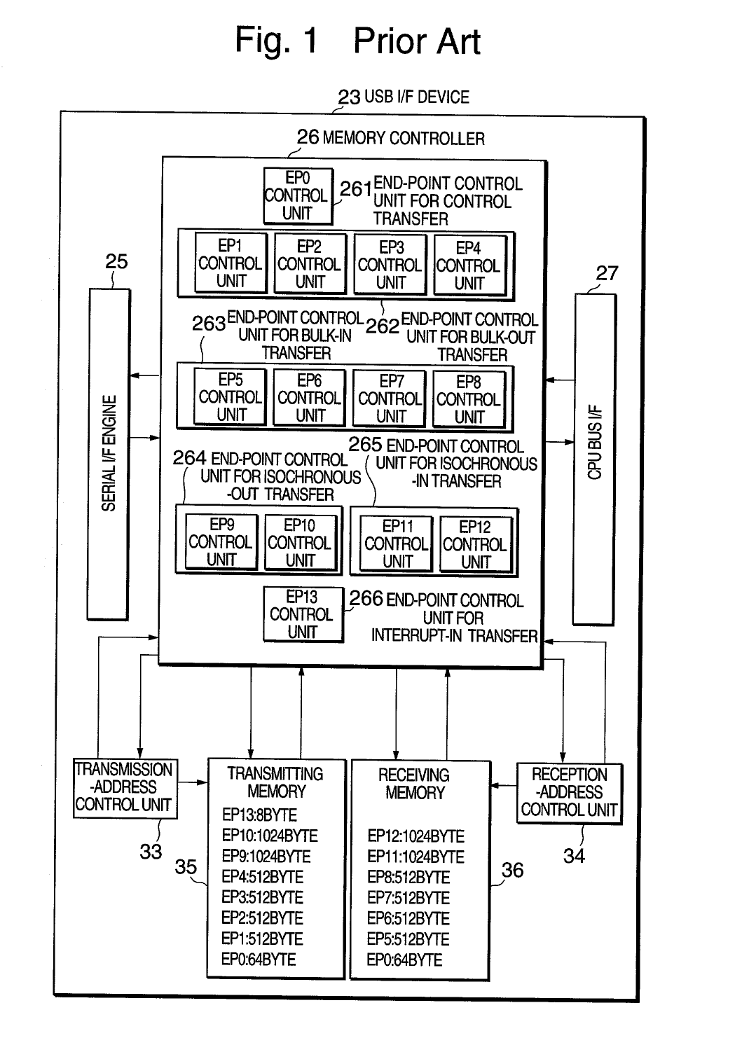

A description is given of the data transfer device as disclosed in the above Japanese Unexamined Patent Application Publication No. 11-328069. FIG. 1 is a block diagram of the USB interface device of the terminal adaptor according to the conventional art as disclosed in the above Japanese Unexamined Patent Application Publication No. 11-328069, in comparison with that of the present invention. Referring to FIG. 1, a USB interface device 23 comprises a serial interface engine 25, a memory controller 26, a CPU bus interface 27, a transmission-address control unit 33, a transmitting memory 35, a receiving memory 36, and a reception-address control unit 34.

An end-point control unit 261 for transferring control data of the memory controller 26 controls an end point EPO at which the control data is transferred. The end-point control unit 261 requires a memory capacity of 64 bytes for respective transmission and reception of data.

An end-point control unit for bulk-out transfer 262 controls end points EP1 to EP4 for bulk-out transfer. The end-point control unit 262 requires a memory capacity of 512 bytes for receiving data.

An end-point control unit for bulk-in transfer 263 controls end points EP5 to EP8 for bulk-in transfer. The end-point control unit 263 requires a memory capacity of 512 bytes for transmitting data.

An end-point control unit for isochronous-out transfer 264 controls end points EP9 and EP10 for isochronous-out transfer. The end-point control unit 264 requires a memory capacity of 1,024 bytes for receiving data.

An end-point control unit for isochronous-in transfer 265 controls end points EP11 and EP12 for isochronous in transfer. The end-point control unit 265 requires a memory capacity of 1,024 bytes for transmitting data.

An end-point control unit for interrupt-in transfer 266 controls an end point EP13 for interrupt-in transfer. The end-point control unit 266 requires a memory capacity of 8 bytes for transmitting data.

The transmitting memory 35 for storing the transmission data requires a memory capacity of total 4,168 bytes.

The receiving memory 36 for storing the reception data requires a memory capacity of total 4,160 bytes.

In the above conventional art, the total memory capacity is 8,328 bytes to assure the memory area for each end point.

According to the first embodiment, the single memory area can be shared at all end points and, therefore, a memory of the capacity corresponding to the number of end points having the maximum packet size, namely, of 1,024 bytes may be held. That is, in the example, the memory can be reduced to ⅛.

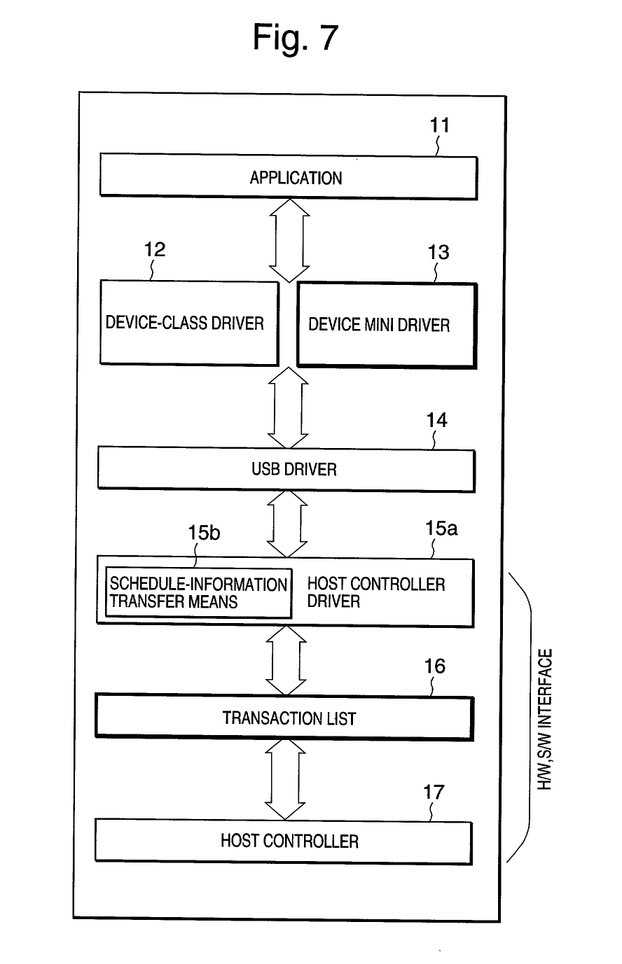

Next, a modification of the first embodiment in the present invention will be described with reference to the drawings. Referring to FIG. 7, although the fundamental structure is the same as that of FIG. 3, for example, means for obtaining the schedule information is provided for a component excluding the device mini driver.

Referring to FIG. 3 and FIG. 7 which shows the example in which the means for obtaining the schedule information is provided for a host controller driver 15a, the modification is different from the first embodiment in a method for obtaining the transaction list 16 and a method for requesting the transfer of the schedule information. Further, according to the modification, differently from the first embodiment, the host controller driver 15a comprises therein schedule-information transfer means 15b having a function for transferring the schedule information to the USB peripheral device to which the data is transferred.

Referring to FIG. 3, the host controller 17 or the host controller driver 15 comprise means for extracting from the transaction list 16, the schedule information of each USB peripheral device which is connected to a USB bus and periodically transferring the extracted schedule information. However, according to the modification of the first embodiment, schedule information 15b on each USB peripheral device connected to the USB bus is extracted from the host controller driver 15a. Alternatively, the schedule information on each USB peripheral device connected to the USB bus is extracted from the host controller 17 and the extracted schedule information is periodically transferred.

Although the host controller 17 has the conventional structure, it transfers the schedule information of the present invention by a data transmitting function as a normal function of the host controller.

By using these methods, a designer of the USB peripheral device may use the conventional art when the device mini driver is designed.

According to the modification, a method for controlling the USB interface device which receives the schedule information is the same as that according to the first embodiment.

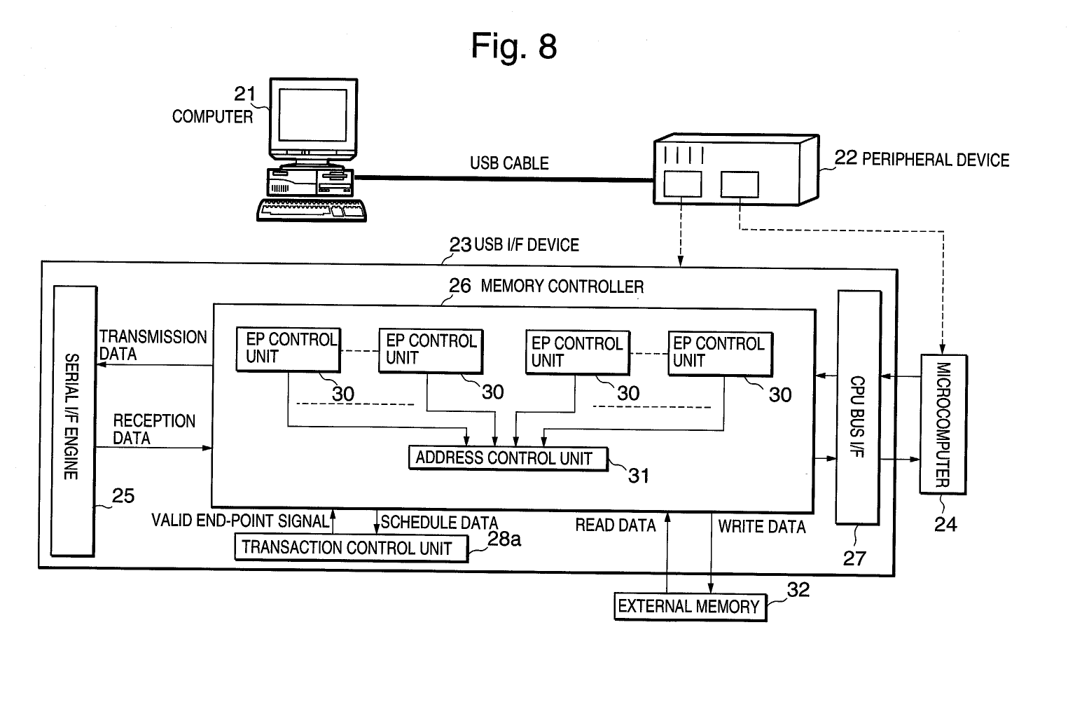

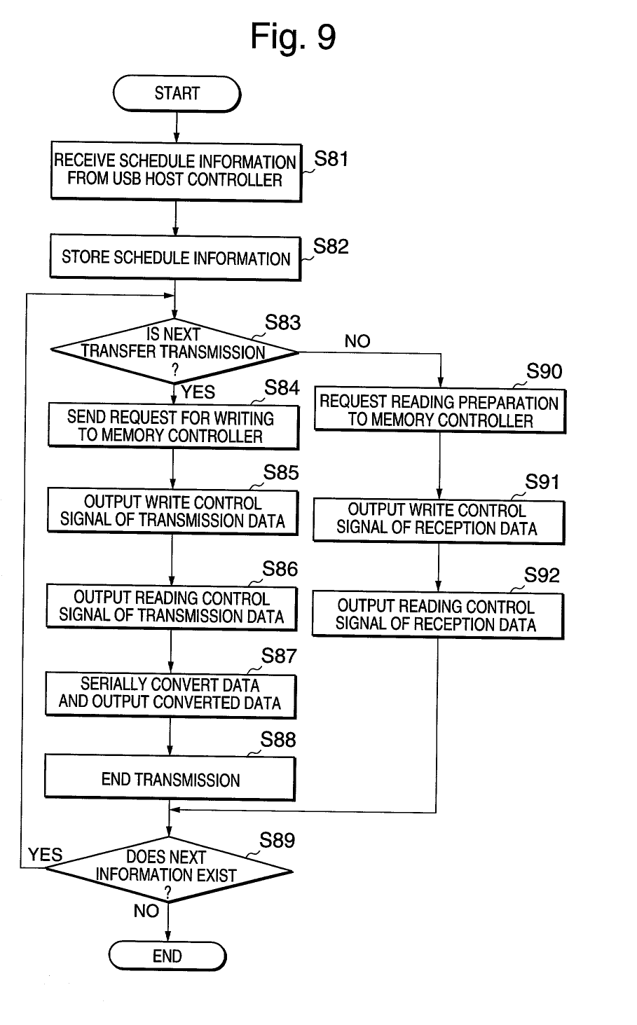

Next, a second embodiment of the present invention will be described. FIG. 8 is a block diagram showing the structure of a USB interface device of a peripheral device according to the second embodiment of the present invention. FIG. 9 is a flowchart for explaining a control method according to the second embodiment. Referring to FIGS. 8 and 9, according to the second embodiment, differently from the first embodiment, the USB interface device 23 does not include a receiving and transmitting memory and an external memory 32 provided outside the USB interface device 23 is used.

According to the second embodiment, a description is given of only processing different from the flowchart for explaining the control method according to the first embodiment. If the data is next transmitted, the memory controller 26 and the USB interface device 23 output data, an address, and a write signal for writing the transmission data received from the CPU interface 27 to the external memory 32 (processing step S85).

The memory controller 26 and the USB interface device 23 output an address and a read signal for reading the transmission data from the external memory 32 and the reads the data so as to transmit the transmission data to the serial interface engine 25 (processing step 86).

If the next data transfer is reception, the memory controller 26 and the USB interface device 23 output data, an address, and a write signal for writing the reception data received from the serial interface engine 25 to the external memory 32 (processing step S91).

The memory controller 26 and the USB interface device 23 output an address and a read signal for reading the reception data from the external memory 32 and the reads the data so as to transmit the reception data to the CPU interface 27 (processing step 92).

As mentioned above, the USB interface device does not include the receiving and transmitting memory but the external memory can be used.

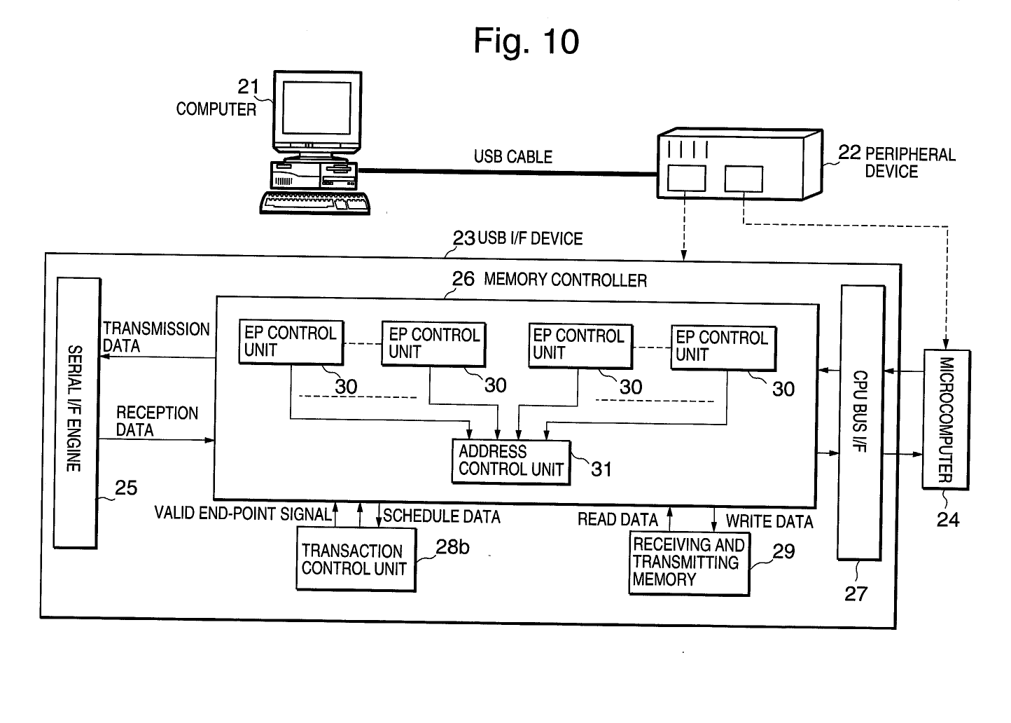

Next, a third embodiment of the present invention will be described with reference to the drawings. FIG. 10 is a block diagram showing the structure of a USB interface device of a peripheral device according to the third embodiment of the present invention. Referring to FIG. 10, according to the third embodiment, the first point different from the first embodiment is that the switching of the control for writing and reading data to a receiving and transmitting memory by a schedule data decoder is performed by a microcomputer which is included in the peripheral device 22 and is connected to the CPU bus interface 27 of the USB interface device 23.

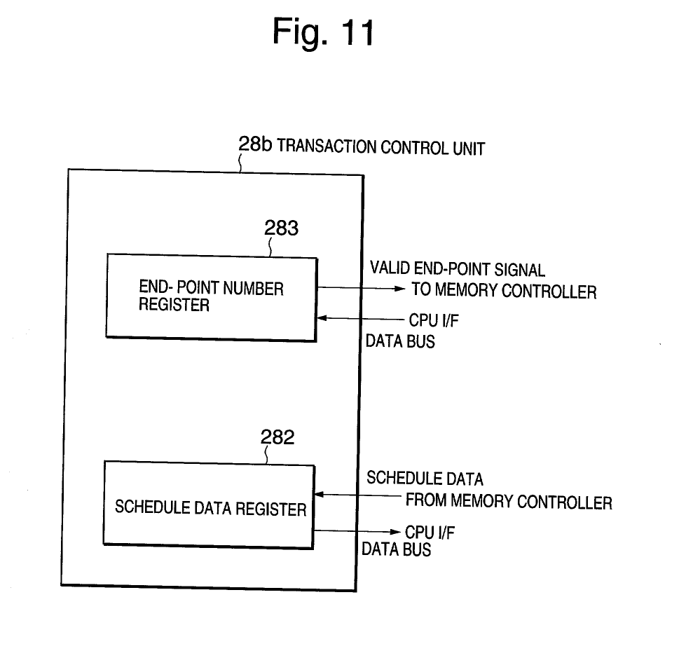

FIG. 11 is a diagram showing the structure of a transaction control unit 28b according to the second embodiment. Referring to FIG. 11, according to the third embodiment, the second point different from the first embodiment is that an end-point number register 283 is provided in place of the schedule data decoder 281.

That is, according to the third embodiment, the end-point number register 283 sets the valid end-point signal at the end point to be the H-level based on the data written from the CPU bus interface 27.

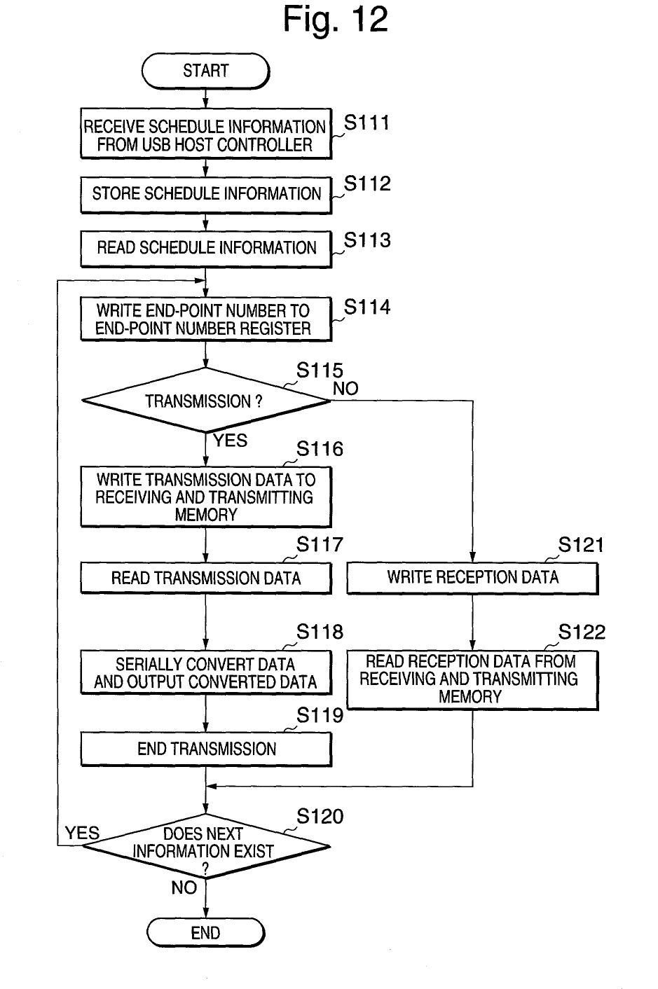

Next, a control method according to the third embodiment will be described with reference to FIG. 12. FIG. 12 is a flowchart for explaining the control method according to the third embodiment. Herein, a description is given of only processing step different from the control method according to the first embodiment, and the description of other processing is omitted.

The memory controller 26 receives the valid end-point signal at the H-level from the end-point number register 283, reads data to be stored to the schedule data register 282, and transmits the read data to the microcomputer 24 in the peripheral device from the CPU bus interface 27 (processing step S113).

The microcomputer 24 identifies the end-point number to which the data is to be next transferred, from the received schedule information, and writes the end-point number to the end-point number register 283 via the CPU bus interface 27 (processing step S114).

The end-point number register 283 sets the valid end-point signal based on the written and stored data to be the H-level (processing step S115).

After completing the transmission/reception processing of one-packet data, if the next transfer information exists, the processing from processing step S114 is repeated. If the next transfer information does not exist, the buffering control ends (processing step S120).

As mentioned above, the buffer control can be performed not by the hardware in the USB interface device but by the software for controlling the microcomputer 24 in the USB interface device and, thus, the same advantage as that of the first embodiment can be obtained.

The programs for executing the flowcharts of the control method according to the first to third embodiments are stored and executed in the microcomputer 24.

As described above, in the USB interface device of the peripheral device, and the control method, the program, and the USB interface system thereof according to the present invention, the memory controller of the USB interface device performs the buffering control in accordance with the schedule information of the host controller, thereby sharing the single memory area at all the end points. Accordingly, the circuit scale of the USB interface device can extremely be reduced without the reduction in effective speed of the data transfer.

What is claimed is:

1. A USB interface device of a peripheral device, for periodically receiving and transmitting from a computer a transaction list including a data size, an end-point number, and a device address as schedule information stored in said computer for data transfer via a USB interface, said USB interface device comprising:
memory means at least one of memory means for writing reception and transmission data and memory means for reading the written reception and transmission data to/from said computer via the USB interface; and
memory control means at least one of memory control means for controlling the buffering of writing the reception and transmission data to said memory means and memory control means for controlling the buffering of reading the written reception and transmission data, based on said transaction list.

2. A USB interface device of a peripheral device, for periodically receiving and transmitting from a computer a transaction list including a data size, an end-point number, and a device address as schedule information stored in said computer for data transfer via a USB interface, said USB interface device comprising:
memory means at least one of memory means for writing reception and transmission data and memory means for reading the written reception and transmission data to/from said computer via the USB interface; and
memory control means at least one of memory control means for controlling the buffering of writing the reception and transmission data to said memory means and memory control means for controlling the buffering of reading the written reception and transmission data, based on said transaction list,
wherein said memory means shares single memory means for receiving and transmitting data to/from said computer.

3. A USB interface device of a peripheral device, for periodically receiving and transmitting from a computer a transaction list including a data size, an end-point number, and a device address as schedule information stored in said computer for data transfer via a USB interface, said USB interface device comprising:
memory means at least one of memory means for writing reception and transmission data and memory means for reading the written reception and transmission data to/from said computer via the USB interface; and
memory control means at least one of memory control means for controlling the buffering of writing the reception and transmission data to said memory means and memory control means for controlling the buffering of reading the written reception and transmission data, based on said transaction list,
wherein said memory means shares single memory means for receiving and transmitting data to/from said computer, and
all end points as minimum units of the data transfer via the USB interface in said peripheral device share single memory means at least one of single memory means for writing and single memory means for reading the reception and transmission data in response to the control operation which is performed by combining a data-transfer requesting function for transmitting the schedule information from said computer and a buffering-control function of the reception and transmission data in accordance with the schedule information transferred by said data-transfer requesting function.

4. A USB interface device of a peripheral deice according to claim 2,
wherein said memory means sets a memory capacity of said memory means in advance to be a capacity value corresponding to a capacity at the end point having a maximum packet size among from said end points.

5. A USB interface device of a peripheral deice according to claim 3,
wherein said memory means sets a memory capacity of said memory means in advance to be a capacity value corresponding to a capacity at the end point having a maximum packet size among from said end points.

6. A USB interface device of a peripheral device, for periodically receiving and transmitting from a computer a transaction list including a data size, an end-point number, and a device address as schedule information stored in said computer for data transfer via a USB interface, said USB interface device comprising:
a serial interface engine for converting reception and transmission data in parallel or serially;
memory means for storing said reception and transmission data;
a CPU bus interface as an interface between said peripheral device and a microcomputer incorporated therein, at least one of for writing the reception and transmission data transferred to said microcomputer and for reading the reception and transmission data from said memory means;
a transaction control unit for activating an end point based on schedule information transferred from said computer for the data transfer via a USB interface; and
a memory controller for controlling the buffering to said memory means in accordance with the reception and transmission of said schedule information transferred from said computer.

7. A USB interface device of a peripheral device according to claim 6, wherein said memory controller has a function for the data transfer to the end point as the minimum unit in the data transfer via the USB interface and for the hand shake and a function for storing reception data to a schedule register in said transaction control unit, and said memory controller comprises:
an end-point control unit corresponding to the number of end points; and
an address control unit for selecting a control signal from said end-point control unit based on an activated valid end-point signal and for generating an address in accordance with the input and output of data to said memory means.

8. A USB interface device of a peripheral device according to claim 6, wherein said transaction control unit comprises:
a schedule data register for inputting and storing the schedule information from said memory controller; and
a schedule data decoder for inputting next transfer information from said schedule data register, decoding the inputted schedule information, and setting only the end point as a transfer target to be valid.

9. A USB interface device of a peripheral device according to claim 6, further comprising
external memory means which is provided outside said USB interface means, in place of said memory means.

10. A USB interface device of a peripheral device, said peripheral device comprising a microcomputer for periodically receiving and transmitting from a computer a transaction list including a data size, an end-point number, and a device address as schedule information stored in said computer for data transfer via USB interface means, identifying the end-point number as a next-transfer target based on the schedule information, and transferring the identified end-point number to said USB interface means, said USB interface device comprising:
a serial interface engine for converting reception and transmission data to data at least one of parallel data and serial data;
memory means for storing the reception and transmission data;
a transaction control unit for temporarily storing the schedule information from said computer and activating an end point based on the end-point number designated by said microcomputer;
a CPU bus interface as an interface to said microcomputer, at least one of for writing the receiving and transmitting data transferred to said microcomputer to said memory means and for reading the reception and transmission data from said memory means, transferring the schedule information read from said transaction control unit to said microcomputer, and writing the end-point number to be transferred from said microcomputer to said transaction control unit; and
a memory controller for controlling the buffering to said memory means in accordance with the reception and transmission of the schedule information transferred by said computer.

11. A USB interface device of a peripheral device according to claim 10, wherein said transaction control unit comprises:
a schedule data register for inputting and storing the schedule information from said memory controller; and
an end-point number register for setting the end point to be valid based on the data written from said CPU bus interface.
